(19) United States
(12) Patent Application Publication
(10) Pub. No.: US 2023/0295971 A1
(43) Pub. Date: Sep. 21, 2023

(54) HELICAL COMPRESSION SPRING WITH NON-ROUND CROSSSECTION FOR AN ACTUATOR FOR OPENING AND CLOSING A DOOR OR A TAILGATE OF A CAR

(71) Applicant: NV Bekaert SA, Zwevegem (BE)

(72) Inventors: Pieter GHEKIERE, Helkijn (BE); Wim VAN HAVER, Aalter (BE); Olivier CARDON, De Pinte (BE); Johan VAN DE VELDE, Lochristi (BE); Igor VRAZIC, Trnava (SK)

(73) Assignee: NV Bekaert SA, Zwevegem (BE)

(21) Appl. No.: 18/007,943

(22) PCT Filed: Apr. 21, 2021
(86) PCT No.: PCT/EP2021/060331

§ 371 Date: Dec. 2, 2022

(30) Foreign Application Priority Data
Jun. 12, 2020 (EP) 20179755.2

(51) Int. Cl. E05F 1/10

(52) U.S. Cl. CPC E05F 1/105; E05Y 2800/674; E05Y 2900/546; E05Y 2900/532

(57) ABSTRACT

Helical compression spring for use in an actuator for opening and closing a door or a tailgate of a car has an outer diameter between 15 and 50 mm and comprises a helically coiled steel wire. The steel wire has a non-circular cross-section with an equivalent diameter d (in mm) of the steel wire is between 1 mm and 12 mm. The cross-section may have at least two opposing parallel sides. The cross-section further has rounded edges, wherein the rounded edges have a radius of curvature ranging from 0.10 mm to 5.0 mm. The microstructure of the steel wire in the helical compression spring is cold deformed pearlite. In comparison with helical compression springs with round cross-sections, the non-round helical compression springs may occupy less space or reach higher breaking loads within the same space.

### TECHNICAL FIELD

The invention relates to a helical compression spring for an actuator for opening and closing a door or a tailgate of a car. The invention further relates to an actuator for opening and closing a door or a tailgate of a car.

### Background Art

SUVs (Sports Utility Vehicles) know increased popularity. SUVs have a large—and thus heavy—tailgate. It is known to use helical compression steel springs in the actuators to open and close the tailgate of such SUVs.

There is an increased trend to use motor operated tailgate opening and closing actuators. US2018/0216391A1 and US2017/0114580A1 disclose such actuators.

In such typical actuators, the tailgate is opened by releasing the forces of a helical steel wire spring operating in compression mode. The tailgate is closed by the operation of a motor; whereby the motor compresses the helical steel wire spring. The helical steel wire spring for such applications has to meet very stringent requirements. According to a first requirement, the helical spring must have a small diameter, in order to make the tailgate opening and closing system as compact as possible. The spring must be able to withstand the high compressive forces in a consistent way. Relaxation of the spring must be low, as spring relaxation modifies the spring forces for a given compression, which would be negative for the operation of the tailgate opening and closing actuator. Furthermore, the spring must have sufficient fatigue resistance, in that it must survive the required number of opening and closing cycles of the tailgate at high load of the spring. Because of the size of the tailgates of SUVs, the springs used have a long length.

It is known to use steel wires having a martensitic microstructure for producing helical springs for tailgate opening and closing actuators of cars. Steel wires having a martensitic microstructure are typically manufactured by hardening and tempering heat treatment operations.

DE202004015535U1 describes a tailgate opening and closing system of a car. The system comprises a helical steel wire spring. The spring is made from a steel wire having a diameter of at least 1 mm. The steel alloy out of which the steel wire is made comprises 0.5-0.9% by weight of carbon, 1-2.5% by weight of silicon, 0.3-1.5% manganese, 0.5-1.5% by weight of chromium, iron and impurities. The steel alloy optionally comprises 0.05-0.3% by weight of vanadium and/or 0.5-0.3% by weight of niobium and/or tantalum. The steel wire is made via a patenting operation followed by wire drawing. The steel wire is then hardened and tempered to obtain a martensitic microstructure, a tensile strength higher than 2300 N/mm² and a reduction of the cross sectional area at break of more than 40%. The obtained steel wire is cold formed into a helical spring, which is then stress relieved at a temperature between 200° C. and 400° C. The spring can be shot peened to increase its durability.

Helical springs exist that are made with hard drawn steel wire. European Standard EN 10270-1:2011 is entitled “Steel wire for mechanical springs—Part 1: Patented cold drawn unalloyed spring steel wire”. Although the title refers to unalloyed spring steel wire, section 6.1.2 of the standard indicates that the addition of micro-alloying elements may be agreed between the manufacturer and the purchaser. The standard differentiates steel spring wire in two ways. The first way is according to static duty (S) or dynamic duty (D). The second way is according to tensile strength, low (L), medium (M) or high (H). The two ways combined provide 5 grades of spring steel wire (SL, SM, DM, SH and DH) for which the mechanical properties (among which the tensile strength Rm) and quality requirements are given in Table 3 of standard EN 10270-1:2011 as a function of the steel wire diameter. As an example, for steel wire of diameter between 3.8 and 4 mm, the tensile strength Rm for grade DH (the grade that has the highest specified tensile strength) needs to be between 1740 and 1930 MPa.

### DISCLOSURE OF INVENTION

The first aspect of the invention is a helical compression spring, preferably for use in an actuator for opening and closing a door or a tailgate of a car. The helical compression spring has an outer diameter between 15 and 50 mm. The helical compression spring comprises a helically coiled steel wire, wherein the steel wire has a non-circular cross-section.

The equivalent diameter d (in mm) of the steel wire is between 1 mm and 12 mm, e.g. between 2.8 mm and 5.6 mm. The cross-section has at least two opposing parallel sides. The cross-section further has rounded edges. The rounded edges have a radius of curvature ranging from 0.10 mm to 5.0 mm, e.g. ranging from 0.15 mm to 1.0 mm. The microstructure of the steel wire in the helical compression spring is cold deformed pearlite. The terms ‘equivalent diameter’ refer to the diameter of a round wire with the same cross-section as the non-round wire.

The steel wire may comprise a steel alloy, consisting out of between 0.8 and 0.95 wt % C; between 0.2 and 0.9 wt % Mn; between 0.1 and 1.4 wt % Si; between 0.15 and 0.4 wt % Cr; optionally between 0.04 and 0.2 wt % V; optionally between 0.0005 and 0.008 wt % B; optionally between 0.02 and 0.06 wt % Al; unavoidable impurities; and the balance being iron. The steel alloy has a carbon equivalent higher than 1. The carbon equivalent is defined as: C wt %+(Mn wt %/6)+(Si wt %/5)+(Cr wt %/5)+(V wt %/5). The microstructure of the steel wire in the helical compression spring is cold deformed lamellar pearlite.

Surprisingly, the helical compression spring of the invention is ideally suited for use in an actuator for opening and closing a door or a tailgate of a car. Martensitic steel wires are described in the prior art for use in helical compression springs for actuators for opening and closing tailgates. The steel wires required for helical springs for actuators for opening and closing tailgates must have a diameter between 2 and 5 mm and must have a high strength and sufficient ductility. Hardened and tempered steel wires (which have a martensitic microstructure) of these diameters have highest strength. Helically coiled springs made with such hardened and tempered steel wires and having been subjected to the standard post treatments (e.g. stress relieving and shot peening) provide the combination of excellent fatigue life and low relaxation of the spring force. Because of the high demands for springs for actuators for opening and closing tailgates (high compressive forces, low relaxation allowed and fatigue life requirements) which match perfectly with the known properties of martensitic steel wires, the skilled person has a technical prejudice to use martensitic steel wires and not to use cold deformed wires (cold deformed wires have a deformed pearlitic microstructure) for the production of helical compression springs for actuators for opening and closing tailgates. The steel alloys selected in the invention surprisingly provide steel wires with cold deformed pearlitic microstructure which have the combination of steel wire properties (strength, yield strength, ductility) required to obtain helical compression springs that satisfy the demanding requirements for use in actuators for opening and closing a door or a tailgate of a car.

The advantage of a helical compression spring having a steel wire with a non-round cross-section is that more efficient use can be made of the limited space confined to a compression spring intended to function as a tailgate spring.

In one alternative a higher total strength can be achieved per unit area allowing a much higher loading.

In another alternative, instead of going to a higher loading, springs with the same loading can be design using smaller or thinner wire. This may lead to further decreasing the required space needed for the spring.

Preferably the carbon content of the steel alloy is less than 0.93 wt %, more preferably less than 0.9 wt %.

Preferably, the steel alloy comprises less than 0.35 wt % Cr, more preferably less than 0.3 wt % Cr.

When the steel alloy comprises V, preferably the steel alloy comprises less than 0.15 wt % V.

Preferably, the steel alloy comprises between 0.02 and 0.06 wt % Al. It is a benefit of such embodiment that better helical compression springs can be obtained thanks to the higher ductility of the steel wire used to manufacture the helical compression spring.

Preferably, the helical compression spring has an outer diameter less than 40 mm.

Preferably, the helical compression spring has a length in unloaded condition of more than 40 cm. More preferably of more than 60 cm.

Preferably the length of the spring in unloaded condition is less than 1000 mm.

Preferably, the helical compression spring has a spring index between 3 and 8.

The spring index is the ratio of the diameter of the spring (wherein the diameter of the spring for calculating the spring index is the average between the outer diameter and the inner diameter of the spring in unloaded condition) over the diameter of the steel wire of the spring.

Preferably, the steel alloy has a carbon equivalent higher than 1.05; more preferably higher than 1.1.

Preferably, the steel alloy has a carbon equivalent below 1.4, more preferably below 1.3.

Preferably, the diameter of the steel wire is between 2 and 4 mm, more preferably between 2.5 and 3.8 mm.

Preferably, the helical compression spring has a pitch angle between 5 and 10°.

Such helical compression springs can be beneficially used in tailgate opening and closing actuators of cars with trunk closing systems.

Preferably, the steel wire used for helically coiling the helical compression spring has a tensile strength Rₘ (in MPa) higher than the value calculated by the formula 2680-390.71*In(d). More preferably, the tensile strength Rₘ (in MPa) of the steel wire is higher than the value calculated by the formula 2720-390.71*In(d); more preferably higher than the value calculated by the formula 2770-390.71*In(d); and even more preferably higher than the value calculated by the formula 2800-390.71*In(d). With the function “In(d)” is meant the natural logarithm of the diameter d (in mm) of the steel wire. The tensile test to measure the mechanical properties of the steel wires is conducted according to ISO 6892-1:2009 entitled “Metallic materials—Tensile testing—Part 1: Method of test at room temperature”.

Preferably, the percentage reduction of area Z at break in tensile testing of the steel wire used for the production of the helical compression spring is more than 40%. The percentage reduction of area Z is calculated as: Z=100*(Sₒ-Sᵤ)/Sₒ, Sₒ being the original cross section of the steel wire and Sₒ being the smallest cross section of the steel wire after fracture in tensile testing.

Preferably, the steel alloy comprises between 0.3 and 0.6 wt % Mn; or the steel alloy comprises between 0.6 and 0.9 wt % Mn.

Preferably the steel wires comprises in the spring at least 95%—and more preferably at least 97%—by volume of deformed lamellar pearlite.

In a preferred embodiment, the volume percentage of bainite in the microstructure of the steel wire is between 0.2% and 2%, more preferably below 0.5%. Such embodiments have surprisingly shown to be particularly beneficial for the invention. When the microstructure comprises such amounts of bainite, it is an indication that the lamellar pearlite is very fine, favorable to achieve optimum spring formation and excellent mechanical spring properties, without the bainite creating negative effects. The limited amount of bainite is important for the ductility of the steel wire. The low amount of bainite can be achieved by a proper patenting operation in the production process of the steel wire. The volume percentage bainite in the microstructure of the wire can be determined via optical microscopy or scanning electron microscopy using an appropriate etchant.

In a particular advantageous embodiment of the invention, the helical compression spring has a steel wire with a cross-section in the form of a trapezium.

The trapezium has two acute angles and two obtuse angles. The acute angles may have radii of curvature differing from the radii of curvature of the obtuse angles.

The helically coiled steel wire makes bends to obtain the helix form of the compression spring. Most preferably, the longest side of the trapezium is located at the inner side of the bends.

By bending the steel wire the inner side of the bend is subjected to compressive forces and the outer side of the bend is subjected to tensile forces. The inner side becomes a little bit shorter and the outer side a little bit longer. By carefully selecting the dimensions of the trapezium form one may counteract against this phenomenon in order to obtain a square or rectangular cross-section in bent condition and, hence, an optimal and efficient use of the available space.

In another advantageous embodiment of the invention, the cross-section of the steel wire composing the helical compression spring, further comprises two additional opposing parallel sides, thus resulting in a square or rectangular cross-section, apart from the rounded edges.

In yet another advantageous embodiment of the invention, the cross-section of the steel wire constituting the helical compression spring comprises only two opposing parallel sides that are connected with rounded edges.

In still another embodiment of the invention, the cross-section of the steel wire is oval or elliptical.

Optionally, a phosphate coating can be applied on the steel wire before the wire deformation process. The step of helically coiling the steel wire into the helical compression spring can then be performed with the steel wire comprising the phosphate coating at its surface. Such embodiment provides a better helical compression spring because the phosphate coating facilitates the wire deformation and spring coiling operation. Therefore, in a preferred embodiment, the helically coiled steel wire comprises a phosphate coating. In a more preferred embodiment, a thermoset coating layer or a coating layer comprising zinc and/or aluminum flakes in a binder (preferably an inorganic binder is used) is applied onto the phosphate coating layer. In an even more preferred embodiment, the helically coiled steel wire is provided with a layer of flock. With flock is meant a layer of short textile fibers, e.g. polyamide fibers, bonded by means of an adhesive onto the helical compression spring.

In a preferred embodiment, the helically coiled steel wire comprises a metallic coating layer. The metallic coating layer comprises—and preferably consists out of—at least 83% by mass of zinc; optionally aluminum, optionally 0.2-1 wt % magnesium, and optionally up to 0.6 wt % silicon. Such embodiments have the benefit that spring manufacturing is facilitated. Furthermore, no additional (or post-) coating needs to be applied on the helical compression spring to provide the spring with corrosion resistance properties. Furthermore, such metallic coatings avoid the need to apply a flock layer on the helically coiled compression spring. Such flock layer has the function of avoiding noise generation in the actuator for opening and closing the tailgate or door of a car when driving the car. The metallic coating of the helically coiled steel wire also prevents the occurrence of such noise. Preferably, the metallic coating layer is more than 10 g/m², more preferably more than 25 g/m². More preferably, less than 250 g/m², less than 150 g/m². The mass of the metallic coating layer is expressed per unit of surface area of the steel wire.

It is known to apply on the already coiled helical compression springs polymer coatings to provide the spring with corrosion resistance. Such approach is done on prior art helical compression springs made from steel wire having a martensitic microstructure. Such coatings can e.g. be thermoset polymer coatings (e.g. comprising an epoxy backbone or an acrylic backbone or an combined epoxy/acrylic backbone) or coatings comprising zinc flakes in a binder. The application—according to the invention—of a metallic coating layer on the steel wire before or in between deforming operations, and coiling the helical compression spring with such steel wire allows eliminating the step of coating the spring using thermoset polymer coatings or coatings comprising zinc or aluminium flakes in a binder.

In embodiments wherein the helically coiled steel wire comprises a metallic coating layer, preferably, the metallic coating layer provides the surface of the helical compression spring.

Optionally, when the helically coiled steel wire comprises a metallic coating layer, the metallic coating layer comprises other active elements, each in individual quantities of less than 1% by weight.

Preferably, when the helically coiled steel wire comprises a metallic coating layer, the metallic coating comprises at least 88 wt % of zinc, more preferably at least 90 wt % of zinc. More preferably, the metallic coating layer comprises at least 93 wt % of zinc.

Preferably, when the helically coiled steel wire comprises a metallic coating layer, the metallic coating comprises—and preferably consists out of—zinc, at least 4% by weight of aluminum—and preferably less than 14% by weight of aluminum —; optionally between 0.2 and 2 wt % magnesium (and preferably less than 0.8 wt % Mg); optionally up to 0.6 wt % silicon; optionally up to 0.1 wt % rare earth elements, and unavoidable impurities.

Preferably, when the helically coiled steel wire comprises a metallic coating layer, the metallic coating layer comprises—and preferably consists out of—between 86 and 92 wt % Zn and between 14 and 8 wt % Al; and unavoidable impurities.

Preferably, such metallic coating layer has a mass between 35 and 60 g/m².

Preferably, when the helically coiled steel wire comprises a metallic coating layer, the metallic coating layer consists out of zinc, between 3 and 8 wt % aluminum;

optionally 0.2-1 wt % magnesium; optionally up to 0.1 wt % rare earth elements;

and unavoidable impurities. Preferably, such metallic coating layer has a mass between 60 and 120 g/m².

Preferably, when the helically coiled steel wire comprises a metallic coating layer, the metallic coating layer consists out of zinc, between 3 and 8 wt % aluminum;

between 0.2-2 wt (and preferably less than 0.8 wt %) Mg; and unavoidable impurities. It is a particular benefit that such metallic coating layer can be made thin while still having good corrosion protection properties. A thinner coating layer also facilitates coiling of the helical compression spring. Such metallic coating layer can e.g. be less than 60 g/m². Preferably between 25 and 60 g/m².

Preferably, when the helically coiled steel wire comprises a metallic coating layer, the mass of the metallic coating layer is between less than 120 g/m², more preferably the mass of the metallic coating layer is between 20 and 80 g/m², more preferably less than 60 g/m² of the surface of the helical compression spring, even more preferably less than 40 g/m² of the surface of the helical compression spring.

Preferably, when the helically coiled steel wire comprises a metallic coating layer, the metallic coating layer comprises a globularized aluminum rich phase. Such globularized aluminum rich phase is created in deforming as the steel wire is heated by the deformation energy; and even to a larger extent when a stress relieving heat treatment is performed on the helical compression spring after coiling it. It is believed that the globularized aluminum rich phase improves the corrosion resistance of the metallic coating layer; such that a thinner metallic coating layer can be used.

Preferably, when the helically coiled steel wire comprises a metallic coating layer, the coated steel wire comprises an intermetallic coating layer provided between the steel wire and the metallic coating layer. The intermetallic coating layer comprises an FeₓAl_{y} phase. More preferably the intermetallic coating layer provides between 30 and 65% of the combined thickness of the intermetallic coating layer and the metallic coating layer. The intermetallic layer is beneficial as it creates the required adhesion of the metallic coating layer, in order to allow the steel wire to be coiled into a helical compression spring without damage to the metallic coating layer. A thinner intermetallic coating layer risks to provide flaking when coiling the spring; a thicker coating risks that coilability is not good. The intermetallic coating layer comprising an FeₓAl_{y} phase is obtained when using a double dip process to apply the metallic coating layer. A first dip is performed in a zinc bath. A FeₓZn_{y} layer is formed on the steel surface. The second dip is performed in a bath comprising Zn and Al. In the second bath, the FeₓZn_{y} layer formed in the first bath is converted to an intermetallic coating layer comprising an FeₓAl_{y} phase.

Preferably, when the helically coiled steel wire comprises a metallic coating layer, the coated steel wire comprises an inhibition layer. The inhibition layer is provided between the steel wire and the metallic coating layer. The inhibition layer is provided by an FeₓAl_{y} phase. Preferably, the inhibition layer is less than 1 μm thick. A coated steel wire with such inhibition layer can be obtained by using a single dip process to apply the metallic coating layer. The steel surface is activated, e.g. via the Sendzimir process, and the steel wire is immersed in a bath comprising molten Zn and Al. The steel wire is wiped after immersion in the bath and cooled.

In a preferred embodiment wherein the helically coiled steel wire comprises a metallic coating layer, the metallic coating layer consists out of zinc and unavoidable impurities. More preferably, the mass of such metallic coating layer is more than 80 g/m², more preferably more than 100 g/m².

In preferred embodiments, the steel alloy comprises between 0.15 and 0.35 wt % Si, or the steel alloy comprises between 0.6 and 0.8 wt % Si, or the steel alloy comprises between 0.8 and 1.4 wt % Si.

In more preferred embodiments wherein the helically coiled steel wire comprises a metallic coating, the steel alloy comprises between 0.6 and 1.4 wt % Si; more preferably between 0.8 and 1.4 wt % Si. Such embodiments are particularly beneficial, as a coated steel wire with high strength can be obtained, as the high amount of Si prevents loss of strength of the steel wire in the hot dip process when applying the metallic coating in an intermediate step in the wire drawing process.

In a preferred helical compression spring, the steel alloy consists out of between 0.83 and 0.89 wt % C, between 0.55 and 0.7 wt % Mn, between 0.1 and 0.4 wt % Si, between 0.15 and 0.3 wt % Cr, between 0.04 and 0.08 wt % V, optionally between 0.02 and 0.06 wt % Al; and unavoidable impurities and the balance being iron.

In a preferred helical compression spring, the steel alloy consists out of between 0.83 and 0.89 wt % C, between 0.55 and 0.7 wt % Mn, between 0.55 and 0.85 wt % Si, between 0.15 and 0.3 wt % Cr, between 0.04 and 0.08 wt % V, optionally between 0.2 and 0.06 wt % Al; and unavoidable impurities and the balance being iron.

In a preferred helical compression spring, the steel alloy consists out of between 0.9 and 0.95 wt % C, between 0.2 and 0.5 wt % Mn, between 1.1 and 1.3 wt % Si, between 0.15 and 0.3 wt % Cr; and unavoidable impurities and the balance being iron.

Preferably, the steel wire in the helical compression spring has a deformation reduction of more than 75%. The wire rod from which the steel wire has been deformed, or the steel wire itself has undergone a patenting operation to create a pearlitic microstructure; followed by steel wire drawing or rolling operations, or a combination of both drawing and rolling. The deformation reduction (in %) is defined as 100*(A₀−A₁)/A₀, wherein A₀ equals the area of the cross section of the wire rod or the steel wire after patenting and before deformation; and A₁ the area of the cross section of the deform steel wire used to manufacture the spring. During the mechanical deformation the pearlite grains will be oriented into longitudinal direction of the steel wire. The level of orientation of the pearlite grains is determined by the deformation reduction of the steel wire. The deformation reduction can be assessed from the evaluation of the deformed lamellar pearlite microstructure of the steel wire in the helical compression spring, e.g. by means of light optical microscopy on a longitudinal section (i.e. along the longitudinal direction of the steel wire in the helical compression spring).

In a preferred helical compression spring, after 20000 compressive load cycles of the helical spring between 63% and 37% of its length in unloaded condition, the load loss at 63% of its length is less than 5% (and preferably less than 3%) compared to the load at 63% of its length at the first cycle.

The second aspect of the invention is a method for making a helical compression spring as in any embodiment of the first aspect of the invention. The method comprises the steps of
providing a steel wire rod, preferably with diameter between 7 and 14 mm;
patenting the steel wire rod or a steel wire drawn from the steel wire rod, in order to obtain a pearlitic microstructure;
deforming by drawing or rolling or a combination of drawing and rolling, with deformation reduction more than 75%, the patented steel wire rod having a pearlitic microstructure or the patented steel wire having a pearlitic microstructure; thereby obtaining a steel wire with deformed pearlitic microstructure, with equivalent diameter d (in mm) between 1 and 12 mm;
helically coiling the steel wire into a helical spring;
optionally performing a thermal stress relieving on the helical spring.

The steel wire rod comprises a steel alloy consisting out of between 0.8 and 0.95 wt % C (and preferably less than 0.93 wt % C, more preferably less than 0.9 wt % C); between 0.2 and 0.9 wt % Mn; between 0.1 and 1.4 wt % Si; between 0.15 and 0.4 wt % Cr (and preferably less than 0.35 wt % Cr, more preferably less than 0.3 wt % Cr); optionally between 0.04 and 0.2 wt % V (and preferably less than 0.15 wt % V); optionally between 0.0005 and 0.008 wt % B; optionally between 0.02 and 0.06 wt % Al; unavoidable impurities; and the balance being iron. The steel alloy has a carbon equivalent higher than 1. The carbon equivalent is defined as: C wt %+(Mn wt %/6)+(Si wt %/5)+(Cr wt %/5)+(V wt %/5).

In a preferred method, the deformation operation results in a steel wire with diameter d (in mm) between 2 and 5 mm and having tensile strength Rₘ (in MPa) higher than the value calculated by the formula: 2680-390.71*In(d). More preferably, the deformation results in a steel wire with tensile strength Rₘ (in MPa) higher than the value calculated by the formula 2720-390.71*In(d); more preferably higher than the value calculated by the formula 2770-390.71*In(d); and even more preferably higher than the value calculated by the formula 2800-390.71*In(d). With the function “In(d)” is meant the natural logarithm of the diameter d (in mm) of the steel wire. The tensile test to measure the mechanical properties of the steel wires is conducted according to ISO 6892-1:2009 entitled “Metallic materials—Tensile testing—Part 1: Method of test at room temperature”.

The patenting step to obtain a pearlitic microstructure can be performed on the wire rod or on a steel wire drawn from the wire rod. The patenting step can be performed as an inline step in the wire rod production process, e.g. via direct in-line patenting. The patenting step can also be performed on the wire rod or on a steel wire drawn from the wire rod via known patenting technologies using either appropriate molten metals baths (such as Pb) or alternatives like fluidized bed, molten salts and aqueous polymers. Prior to wire drawing, a pickling and wire coating step can be performed.

Optionally, a phosphate coating can be applied on the steel wire before the wire deformation process. The step of helically coiling the steel wire into the helical spring can then performed with the steel wire comprising the phosphate coating at its surface. Such embodiment provides a better helical compression spring because the phosphate coating facilitates the wire mechanical deformation and spring coiling operation.

Preferably, after the patenting operation; and before deformation or between deformation steps, a metallic coating is applied on the steel wire via hot dip. The metallic coating comprises at least 84% by mass of zinc; and optionally aluminum.

Preferably, the method of making the helical compression spring comprises the step of thermally stress relieving the helical compression spring after coiling it. More preferably, the thermal stress relieving heat treatment step is performed at a temperature below 450° C. on the helical compression spring after its formation. More preferably, the stress relieving heat treatment step is performed at a temperature below 300° C., more preferably below 275° C.

Optionally, other process steps can be applied to the helical compression spring after stress relieving, e.g. hot setting or multiple cold setting. With hot setting is meant that the spring is kept at an elevated temperature in compressed state during some time. With cold setting is meant that the spring is compressed for a number of cycles at room temperature. Such setting operations enable the spring to achieve more strict limited spring relaxation requirements.

The third aspect of the invention is an actuator for opening and closing a door or a tailgate of a car. The actuator comprises a helical compression spring as in any embodiment of the first aspect of the invention, for opening a door or the tailgate of a car when compressive forces of the helical compression spring are released; and a motor. The motor is provided for compressing the helical compression spring in order to close the door or the tailgate of the car. Preferably, the actuator comprises two connectors, one for connecting the actuator to the door or to the tailgate; and the other one for connecting the actuator to the body of the car.

In preferred actuators, the helically coiled steel wire comprises a metallic coating layer comprising at least 84% by weight of zinc. More preferably, the metallic coating layer provides the surface of the helical compression spring. Such embodiments have the benefit that noise in the actuator is prevented when driving the car. It is common practice in prior art actuators for opening and closing a door or a tailgate of a car, to apply a flock layer on the helical compression spring: a layer of short textile fibers (e.g. polyamide fibers) are bonded by means of an adhesive onto the helical compression spring, after coiling of the spring; this way, a velvet layer is created that acts as noise dampening on the tightly compressed spring in the actuator. The use of the metallic coating layer has shown to eliminate the need of applying a flock layer onto the helical compression spring.

### BRIEF DESCRIPTION OF FIGURES IN THE DRAWINGS

FIG. 1 shows an SUV comprising an actuator for opening and closing its tailgate.

FIG. 2 shows an actuator for opening and closing a tailgate of a car.

FIG. 3 shows a helical compression spring as in the invention.

FIG. 4 shows a square cross-section of a steel wire.

FIG. 5 shows an elliptical cross-section of a steel wire.

### MODE(S) FOR CARRYING OUT THE INVENTION

TABLE I
Examples of steel alloys that can be used in the invention.

| | C (wt %) | | Mn (wt %) | | Si (wt %) | | Cr (wt %) | | V (wt %) | | Al (wt %) | |
|---|---|---|---|---|---|---|---|---|---|---|---|---|
| Alloy | min | max | min | max | min | max | min | max | min | max | min | max |
| A | 0.84 | 0.88 | 0.60 | 0.70 | 0.15 | 0.35 | 0.20 | 0.30 | 0.04 | 0.09 | 0.02 | 0.06 |
| B | 0.84 | 0.88 | 0.60 | 0.70 | 0.60 | 0.80 | 0.20 | 0.30 | 0.04 | 0.09 | 0.02 | 0.06 |
| C | 0.80 | 0.84 | 0.70 | 0.85 | 0.15 | 0.35 | 0.20 | 0.30 | 0.05 | 0.08 | 0.02 | 0.06 |
| D | 0.90 | 0.95 | 0.25 | 0.45 | 0.15 | 0.30 | 0.15 | 0.30 | | | | 0.01 |
| E | 0.90 | 0.95 | 0.25 | 0.45 | 1.10 | 1.30 | 0.15 | 0.30 | | | | 0.01 |
| G | 0.90 | 0.95 | 0.30 | 0.60 | 1.10 | 1.30 | 0.20 | 0.40 | | | | |
| H | 0.90 | 0.95 | 0.30 | 0.60 | 1.10 | 1.30 | 0.20 | 0.40 | | | | 0.04 |
| I | 0.88 | 0.94 | 0.35 | 0.55 | 1.10 | 1.30 | 0.20 | 0.30 | | | | |
| J | 0.90 | 0.94 | 0.35 | 0.55 | 1.20 | 1.40 | 0.20 | 0.40 | | | | |
| K | 0.85 | 0.90 | 0.60 | 0.70 | 0.15 | 0.35 | 0.20 | 0.30 | 0.04 | 0.08 | 0.02 | 0.06 |

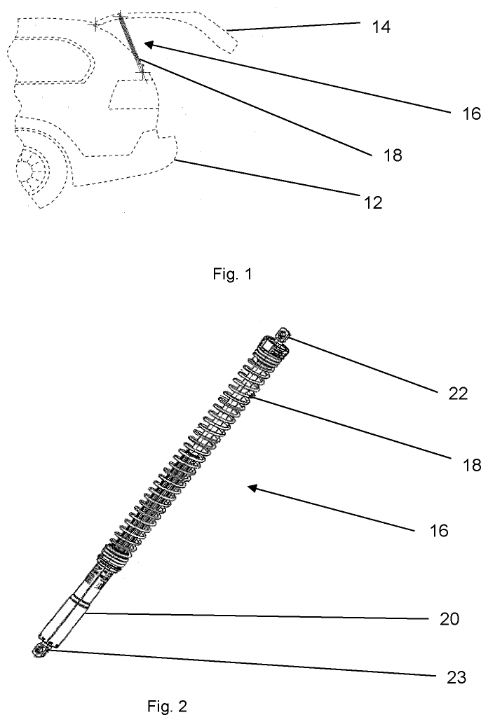

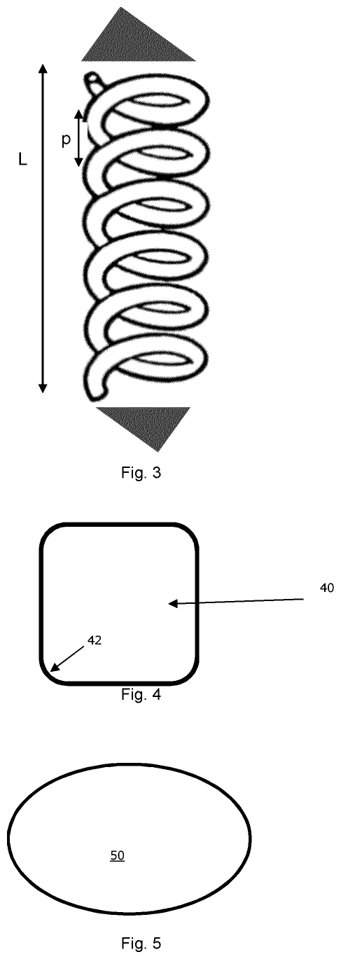

FIG. 1 shows an SUV 12 comprising a tailgate 14 and an actuator 16 for opening and closing the tailgate. The actuator 16 (FIG. 2 shows the actuator 16 for opening and closing the tailgate of a car) comprises a helical compression spring 18 and a motor 20. The actuator comprises two connectors 22, 23, one for connecting the actuator to the door or to the tailgate; and the other one for connecting the actuator to the body of the car. The helical compression spring is provided for opening the tailgate when compressive forces of the helical compression spring are released. The motor is provided for compressing the helical compression spring in order to close the tailgate. An example of a helical compression spring that can be used is shown in FIG. 3, such spring has a length L and a pitch p.

The helical compression spring comprises a helically coiled steel wire. The equivalent diameter d (in mm) of the helically coiled coated steel wire is between 1 and 12 mm.

Table I provides specific examples of steel alloys (with minimum and maximum wt % of the elements in the steel alloy) that can be used for the steel core in the invention. The microstructure of the steel wire in the helically coiled steel wire is cold deformed lamellar pearlite.

A specific example of such helical compression spring has been coiled with a steel wire having a cold deformed pearlitic microstructure and 3.4 mm diameter. The helical compression spring has a length L 0.8 m in unloaded condition. The spring index of the exemplary helical spring is 6.5. The pitch p of the spring is 15.2 mm. The outer diameter of the helical compression spring is 26.8 mm. However not essential for the invention, the steel wire was provided with a metallic coating layer comprising zinc and aluminum.

In order to manufacture the steel wire used for coiling the helical compression spring, a steel wire rod of 10 mm diameter was used.

The steel wire rod was out of a steel alloy consisting out of 0.86 wt % C, 0.63 wt % Mn, 0.2 wt % Si, 0.22 wt % Cr, 0.06 wt % V; 0.04 wt % Al; unavoidable impurities and the balance being iron. This is an alloy of composition “A” of table I. The carbon equivalent is: 0.86+(0.63/6)+(0.2/5)+(0.22/5)+(0.06/5)=1.169.

The 10 mm diameter steel wire rod has been patented to provide it with a pearlitic microstructure; and—although not essential for the invention—has then been provided with a metallic coating via hot dip. The hot dip process used was a double dip process in which the steel wire was first dipped in a bath of molten zinc; followed by dipping the steel wire in a bath comprising 10% by weight of aluminium and the remainder being zinc. The metallic coating layer of the hot dipped steel wire consisted of 10 wt % aluminum and the balance being zinc.

The patented—and hot dipped—wire rod of 10 mm diameter has been cold deformed to a steel wire of 3.4 mm equivalent diameter; this means that a deformation reduction of 88.4% has been applied. The resulting steel wire has a deformed pearlitic microstructure. The tensile strength Rₘ of the steel wire is 2354 MPa; the Rp0.2 value is 1990 MPa, which is 84.5% of the Rₘ value. The percentage reduction of area Z at break in tensile testing of the steel wire is 44.1%.

The metallic coating on the cold deformed wire of 3.4 mm was 45 g/m².

After coiling this coated steel wire into a helical compression spring a thermal stress relieving operation was performed, e.g. by keeping the helical compression spring in unloaded condition at 250° C. during 30 minutes.

The coated steel wire comprised an intermetallic coating layer between the steel core and the metallic coating layer. The intermetallic coating layer provided 45% of the combined thickness of the intermetallic coating layer and the metallic coating layer. The intermetallic coating layer comprises a FeₓAl_{y} phase. It has been observed that the metallic coating layer comprised a globularized aluminum rich phase.

Samples of the steel wire used for making the helical spring have been subject to a thermal treatment in an oven during 30 minutes at an oven temperature of 250° C. After this thermal treatment, tensile testing has been performed on the steel wire sample: the tensile strength Rₘ is 2426 MPa; the Rp0.2 value is 2366 MPa, which is 97.5% of the tensile strength Rₘ; and the percentage reduction of area Z at break was 42%.

Analysis of the steel wire of the helical compression spring has shown that the steel has a cold deformed pearlite microstructure, with more than 97% by volume of cold deformed pearlite and about 1% by volume of bainite.

The helical compression spring was used in an actuator for a tailgate opening and closing actuator of a car. The metallic coating of the coated steel wire provided the surface of the helical compression spring.

### Example for Using the Same Available Space, but Achieve Higher Total Strength

A patented and cold drawn round steel wire provided with a zinc alloy coating for a helical compression spring with a diameter of 3.50 mm has a minimum tensile strength of 2190 MPa or a minimum breaking load of 21075 Newton.

Using the same confined space, a 3.50 mm×3.50 mm square patented and cold deformed steel wire with radii of curvature of 0.35 mm has an equivalent diameter of 3.93 mm and the cross sectional area of this profile is 12.14 mm². Using the same formula as above (but with diameter replaced by equivalent diameter), the minimum tensile strength is 2145 MPa or a minimum breaking load of 26043 Newton, or 23% higher than in case of the round embodiment.

### Example for Using Same Total Strength, but Making the Wire Smaller

In order to achieve a tensile strength of 1970 MPa or a breaking load of 18953 Newton, a round patented and drawn steel wire must have a diameter of 3.30 mm.

To achieve the same total strength of 18953 Newton with patented and cold deformed square steel wire, the dimensions must be 2.94×2.94 mm with radii of curvature of of 0.35 mm. Sₒ a reduction of more than 10% in linear dimension is achieved.

1. A helical compression spring for use in an actuator for opening and closing a door or a tailgate of a car,
wherein the helical compression spring has an outer diameter between 15 and 50 mm,
wherein the helical compression spring comprises a helically coiled steel wire,
wherein the steel wire has a non-circular cross-section,
wherein the equivalent diameter d (in mm) of the steel wire is between 1 mm and 12 mm,
wherein said cross-section has at least two opposing parallel sides,
wherein said cross-section further has rounded edges,
wherein said rounded edges have a radius of curvature ranging from 0.10 mm to 5.0 mm, and
wherein the microstructure of the steel wire in the helical compression spring is cold deformed pearlite.

2. The helical compression spring according to claim 1,
wherein said rounded edges have a radius of curvature ranging from 0.15 mm to 1.0 mm.

3. The helical compression spring according to claim 1,
wherein said cross-section has the form of a trapezium.

4. The helical compression spring according to claim 3,
wherein said trapezium has two acute angles and two obtuse angles,
said acute angles having radii of curvature differing from the radii of curvature of the obtuse angles.

5. The helical compression spring according to claim 3,
said helically coiled steel wire making bends to obtain a helix form,
the longest side of said trapezium being located at the inner side of the bends.

6. The helical compression spring according to claim 1,
said cross-section further comprising two additional opposing parallel sides.

7. The helical compression spring according to claim 1,
wherein said cross-section comprises only two opposing parallel sides that are connected with rounded edges.

8. Helical A helical compression spring, for use in an actuator for opening and closing a door or a tailgate of a car,
wherein the helical compression spring has an outer diameter between 15 and 50 mm,
wherein the helical compression spring comprises a helically coiled steel wire,
wherein the steel wire has a non-circular cross-section,
wherein the equivalent diameter d (in mm) of the steel wire is between 1 mm and 12 mm,
wherein said cross-section is oval or elliptical,
wherein the microstructure of the steel wire in the helical compression spring is cold deformed pearlite.

9. The helical compression spring according to claim 1, wherein said equivalent diameter d (in mm) of the steel wire is between 2.8 mm and 5.6 mm.

10. The helical compression spring according to claim 1, wherein said steel wire has a phosphate coating.

11. The helical compression spring according to claim 1, wherein said steel wire has zinc aluminium coating, the amount of aluminium ranging from 3% to 17% in said coating, the remainder being zinc.

12. The helical compression spring according to claim 11,
said zinc aluminium coating having a weight ranging from 10 g/m² to 250 g/m².

13. The helical compression spring according to claim 11,
said zinc aluminium coating having a weight ranging from 25 g/m² to 150 g/m².

14. The helical compression spring according to claim 4,
said helically coiled steel wire making bends to obtain a helix form,
the longest side of said trapezium being located at the inner side of the bends.

15. The helical compression spring according to claim 8, wherein said equivalent diameter d (in mm) of the steel wire is between 2.8 mm and 5.6 mm.

16. The helical compression spring according to claim 8, wherein said steel wire has a phosphate coating.

17. The helical compression spring according to claim 8, wherein said steel wire has zinc aluminium coating, the amount of aluminium ranging from 3% to 17% in said coating, the remainder being zinc.

18. The helical compression spring according to claim 17,
said zinc aluminium coating having a weight ranging from 10 g/m² to 250 g/m².

19. The helical compression spring according to claim 17,
said zinc aluminium coating having a weight ranging from 25 g/m² to 150 g/m².
